(19) United States
(12) Patent Application Publication
(10) Pub. No.: US 2020/0264284 A1
(43) Pub. Date: Aug. 20, 2020

(54) OPTOELECTRONIC SENSOR AND METHOD FOR DETECTING AN OBJECT

(71) Applicant: SICK AG, Waldkirch (DE)

(72) Inventors: Roger BUSER, Waldkirch (DE); Oliver OSTOJIC, Waldkirch (DE)

(21) Appl. No.: 16/782,657

(22) Filed: Feb. 5, 2020

(30) Foreign Application Priority Data
Feb. 19, 2019 (EP) 19158077.8

(51) Int. Cl. G01S 7/481; G01S 17/04

(52) U.S. Cl. CPC G01S 7/4816; G01S 17/04

(57) ABSTRACT

An optoelectronic sensor for detecting an object in a monitored zone is provided having a light transmitter for transmitting transmitted light of a wavelength range; having a light receiver for producing a received signal from the transmitted light remitted at the object; having a reception optics that is arranged upstream of the light receiver and that has an optical filter adapted to the wavelength range for suppressing extraneous light; and having a control and evaluation unit that is configured to produce a piece of object information from the received signal, An adjustment device for changing the angle of incidence of the remitted transmitted light on the optical filter is provided here.

The invention relates to an optoelectronic sensor for detecting an object in a monitored zone having a light transmitter for transmitting transmitted light of a wavelength range; having a light receiver for producing a received signal from the transmitted light remitted at the object; having a reception optics that is arranged upstream of the light receiver and that has an optical filter adapted to the wavelength range for suppressing extraneous light; and having a control and evaluation unit that is configured to produce a piece of object information from the received signal. The invention further relates to a method for detecting an object in a monitored zone, in which transmitted light is transmitted in a wavelength range, is received again after remission at the object as remitted transmitted light by a reception optics, and is converted into a received signal to produce a piece of object information from the received signal, wherein the reception optics suppresses extraneous light by an optical filter adapted to the wavelength range.

Many optoelectronic sensors work in accordance with the sensing principle in which a light beam is transmitted into the monitored zone and the light beam reflected by objects is received again in order then to electronically evaluate the received signal. The time of flight is here often measured using a known phase method or pulse method to determine the distance of a sensed object. This type of distance measurement is also called TOF (time of flight) or LIDAR (light detection and ranging).

To expand the measured zone, the scanning beam can be moved, as is the case in a laser scanner. A light beam generated by a laser there periodically sweeps over the monitored zone with the help of a deflection unit. In addition to the measured distance information, a conclusion is drawn on the angular location of the object from the angular position of the deflection unit and the site of an object in the monitored zone is thus detected in two-dimensional polar coordinates. The scanning movement is achieved by a rotating mirror in most laser scanners. It is, however, also known to instead have the total measurement head with light transmitters and light receivers rotate, such as is described in DE 197 57 849 B4.

In most cases and in particular in distance measurement, the sensor has to be able to distinguish between useful light and environmental light or interference from other light sources. Depending on the application, for instance in particularly bright environments, with poorly remitting target objects, or with large measurement distances, this can be a very demanding task with an extremely small useful light level.

A known measure to improve robustness with respect to extraneous light is the narrowing of the field of view by a diaphragm that suppresses laterally incident extraneous light. Extraneous light can also be spectrally suppressed. An optical bandpass filter is used for this purpose that is adapted to the wavelength of the transmitted light.

A diaphragm aperture can, however, not be selected as small as desired because the reception optics can in practice be bundled to a light spot size of up to 50 μm, but no further. In fact with all the tolerances and temperature effects, a diaphragm aperture of 200 μm is rather realistic and is even larger with plastic optics or with optics that have not been adjusted with high precision.

Thus, as soon as the effect of a diaphragm has been exhausted, the signal-to-noise ratio can be further improved by an even more exact adaptation of the bandpass filter. The narrower the band of the bandpass filter can be made without damping the useful light, the greater the advantage.

However, the wavelength of the useful light and the pass band of the bandpass filter are subject to tolerances and to drift. The wavelength of the transmitted light transmitted by a laser thus depends on the type of laser, on the specifically installed laser, or at least on its lot (production batch) and on the temperature. The pass band of the bandpass filter varies with the angle of incidence. This has two effects. On the one hand, the pass band is displaced when the bandpass filter is imprecisely oriented. In addition, non-parallel beam bundle portions effectively encounter filter effects having different pass bands.

If, however, the wavelength does not match the pass band, the bandpass filter also blocks useful light. For this reason, the pass band of the bandpass filter is configured with a reserve and is therefore not configured in as narrow a manner as possible. The improvement of the signal-to-noise ratio by an adapted optical bandpass filter consequently also has limits.

An optical bandpass filter can already be arranged in front of or on the large main lens of the reception optics. The incident light is sufficiently collimated there so that a good filter effect results. However, construction problems arise with an autocollimation arrangement; the optical bandpass filter would at least have to have an aperture for the transmitted light via which extraneous light again enters. In addition, a large filter surface having correspondingly high component costs is required.

On an arrangement of the optical bandpass filter in front of the light receiver, these construction difficulties do not arise and a small filter surface is sufficient. The incident beam bundle is, however, no longer in parallel at all behind the focusing main lens and the optical bandpass filter therefore has to cover a large angle of incidence range and for this reason alone may only be of a narrow band with limitations.

DE 10 2014 116 852 A1 describes an optoelectronic sensor having an optical filter element between the reception lens and the light receiver. In this respect, the just described effect is compensated by a curvature of the filter element. The curvature has the effect that the converging light beams are incident perpendicular on the filter element despite their different angles of incidence. However, such a filter element is comparatively expensive. In addition, the other effects that make a coordination of the wavelength of the useful light and the pass band more difficult are not remedied, in particular a maladjustment of the filter element on which the incoming beams are incident obliquely instead of perpendicular.

U.S. Pat. No. 4,106,855 shows an optical system having a lens element that has a spherical surface with an integrated narrow band bandpass filter. The lens element itself and the remaining optics arrangement are, however, extremely too complex and can, for example, not be used in a laser scanner at all.

U.S. Pat. No. 4,184,749 discloses an arrangement of a spherical lens element and a concentric, arcuate lens element that has a likewise concentric, arcuate, narrow band bandpass filter at its outer side. It is the object of the invention to receive light from a large field of view and to disperse it such that the beams exit the concentric lens element radially and thus pass through the arcuate bandpass filter in a perpendicular manner. To implement the lens element with the bandpass filter, a macroscopic curved lens has to be coated with a high effort, which is prohibited for competitive manufacturing costs. The arrangement is also only intended for a large image plane and thus a large light receiver. The arrangement is not adapted and would be unsuitable for a conventional light receiver or for pixels of an optoelectronic sensor.

An optical system for detecting distance information is described in US 2017/0289524 A1. A common reception lens focuses the light on a plurality of mechanical diaphragms behind which a respective small converging lens is seated that collimates the light that is then incident on respective pixels of a light receiver through an optical bandpass filter. The small converging lenses admittedly reduce the angle of incidence on the optical bandpass filter. However, due to the short distance from the pixel, they have to have a relatively large image field. This necessarily has the result that the image becomes blurred.

It is therefore the object of the invention to improve the extraneous light suppression of an optoelectronic sensor of the category.

This object is satisfied by an optoelectronic sensor, in particular a light scanner, and by a method for detecting an object in a monitored zone in accordance with the respective independent claim. A light transmitter generates transmitted light in a specific, preferably narrow, wavelength range. The transmitted light is received again as remitted transmitted light after it has been at least partly reflected back from an object in the monitored zone. The corresponding received signal of a light receiver is evaluated to acquire optically detectable information on the object such as a piece of binary presence information, a distance, or also a color. A reception optics is arranged in front of the light receiver in the reception path of the remitted transmitted light and has an optical filter adapted to the wavelength range of the light transmitter to allow, where possible, only the remitted transmitted light to pass and to mask extraneous light outside its spectrum.

The invention starts from the basic idea of carrying out an adaptation of the optical filter. An adjustment device for this purpose provides that the angle of incidence of the remitted transmitted light on the filter changes. A pass band of the optical filter can be adapted to the wavelength range of the transmitted light in this manner. The adaptation takes place, for example, as the last adjustment step, for instance as part of production. For this purpose, the angle of incidence can preferably be adjusted under otherwise unchanged extraneous light conditions by means of the adjustment device for so long until a maximum received signal level has been reached. Tolerances in the wavelength range, remaining adjustment errors in the reception path, and/or drifting are thus balanced by means of the adjustment device.

The invention has the advantage that extraneous light is efficiently suppressed. No reserves, or at least fewer reserves, are necessary in the pass band due to the adaptability with the aid of the adjustment device so that a particularly good signal-to-noise ratio is achieved. Since it is possible to react to tolerances of the wavelength range of the light transmitter, there are no dependencies on specific light sources, batches, or manufacturers. The optical filter can in all cases be very small and inexpensive.

The adjustment device is preferably configured to tilt the optical filter. The pass band is shifted by the slanting of the filter with respect to the incoming light beams. A very inexpensive adjustment possibility is sufficient for production. In principle, however, an electronic actuator system is also conceivable, for example with an automatic regulation in operation, during servicing, or in the putting into operation on site.

The optical filter is preferably a bandpass filter. The pass band can accordingly be indicated by a lower and upper limit or alternatively a center frequency about which the pass band typically lies symmetrically. A bandpass filter is particularly suitable to suppress extraneous light in that it excludes light both of wavelengths that are too low and too high.

The wavelength range can shift in a tolerance wavelength range due to drifting in the operation of the sensor and/or due to properties of the light transmitter and the optical filter preferably has a pass band that is narrower than the tolerance wavelength range. Drifting is characterized by time-dependent effects, for instance due to aging and in particular temperature. The sensor is adapted to specific environmental conditions such as a specified temperature range. How great the influence of drifting can be can therefore be stated. It is additionally conceivable that the light transmitter deviates from its specified wavelength range. A tolerance wavelength range thus results and, conventionally, the optical filter would be designed with a reserve of its pass band to cover the tolerance wavelength range. In accordance with this embodiment, however, the pass band is selected as narrower, in particular such that only drifting is taken into account and no displacement due to component tolerances. The adjustment device ensures that the particularly narrow pass band matches the actual wavelength range.

The optical filter preferably has a pass band with a full width at half maximum of at most 40 nm, at most 30 nm, at most 20 m, or at most 10 nm. These are some values for a pass band that is too narrow according to a conventional standard with a reserve for tolerances. Typical values for the shift of the center frequency of the light transmitter due to production tolerances are ±10 nm or at best ±5 nm. There is thus hardly any buffer for the compensation of drifting with said values. This is, however, also not even necessary in accordance with the invention because at least the production tolerances are compensated by the adjustment device.

The optical filter is preferably planar. It therefore has no curvatures and is therefore inexpensive.

The optical filter has an area of at most 25 mm², at most 20 mm², at most 15 mm², at most 10 mm², or at most 5 mm². It is preferably at least approximately square so that the boundaries approximately correspond to 5×5 mm², 4×4 mm², 3×3 mm², or 2×2 mm². Such an optical filter is likewise inexpensive and would be much # too small to position it in front of or on the main lens.

The wavelength range of the light transmitter is preferably displaced with the temperature by at most 0.1 nm/K, at most 0.8 nm/K, at most 0.6 nm/K, or at most 0.05 nm/K. This limits the drift over temperature so that a narrower pass band is also still sufficient to still cover the wavelength range displaced by drifting. One possibility is to use a VCSEL in the light transmitter that can reach these values. Alternatively, the light transmitter has a temperature stabilization. The temperature adaptation takes place, for example, using a Peltier element or by an adaptation of the laser current.

The reception optics preferably has a first focusing optical element. The remitted transmitted light is thus focused. A comparatively large main lens or reception lens is frequently used, possibly also an objective having a plurality of lenses or a reflective arrangement.

A diaphragm is preferably arranged downstream of the first focusing optical element; further preferably in the focal plane of the first focusing optical element. This provides a geometrical suppression of extraneous light in addition to the spectral suppression of the optical filter since lateral extraneous light does not reach the light receiver.

The reception optics preferably has a second focusing optical element, in particular a spherical converging lens. The second focusing optical element limits the angle of incidence on the optical filter, that is it aligns the beams incident in a converging manner after the focusing by the main lens with respect to one another so that they extend more in parallel with one another. A spherical converging lens as a second focusing optical element facilitates the adjustment and handling due to its arbitrary rotational symmetry. The manufacture of the glass sphere is very precise at low cost.

The adjustment device is preferably configured to tilt the optical filter and the second focusing optical element, in particular with a center of rotation in the second focusing optical element. In this embodiment, the optical filter is not tilted alone, but rather in a compact assembly of the second focusing optical element and, where present, the diaphragm. The center of rotation for the tilting is preferably in the second focusing optical element and particularly preferably at its center with a spherical shape. The rotation does not then change the optical effect of the second focusing optical element due to its symmetrical properties.

The reception optics preferably has, in this order, a first focusing optical element, a diaphragm, a second focusing optical element, and the optical filter. This order is given from the viewpoint of the incident remitted transmitted light that is accordingly first incident on the main lens and that is incident on the light receiver after the optical filter. A simple adjustment and adaptation to the wavelength range of the useful light, a small cross-section of the light spot, and a small spread of the angles of incidence on the optical filter, or a light beam with only little divergence there are simultaneously achieved with these optical elements.

The control and evaluation unit is preferably configured to determine a distance of the object from a time of flight between the transmission of the transmitted light and the reception of the remitted transmitted light. A distance measuring sensor is thus produced and the distance of the object is determined as the piece of measurement information on the object. Particularly with high ranges, a large amount of environmental light, and/or poorly remitting, dark objects, the proportion of useful light is frequently very low so that a time of flight method greatly profits from the improved extraneous light suppression.

The sensor is preferably configured as a laser scanner and for this purpose has a movable deflection unit for the periodic deflection of the transmitted light in the monitored zone. The monitored zone is thus substantially increased in size over a one-dimensional sensor, namely to a scanning plane having an angular range of up to 360° and, with an additional deflection in elevation and/or with a use of a plurality of scanning beams set into elevation, even to a three-dimensional spatial zone. The laser scanner preferably uses a time of flight method for the distance measurement and thus generates 3D measurement points within the scanning plane or even in space while taking account of the respective angles at which the transmitted light is transmitted.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

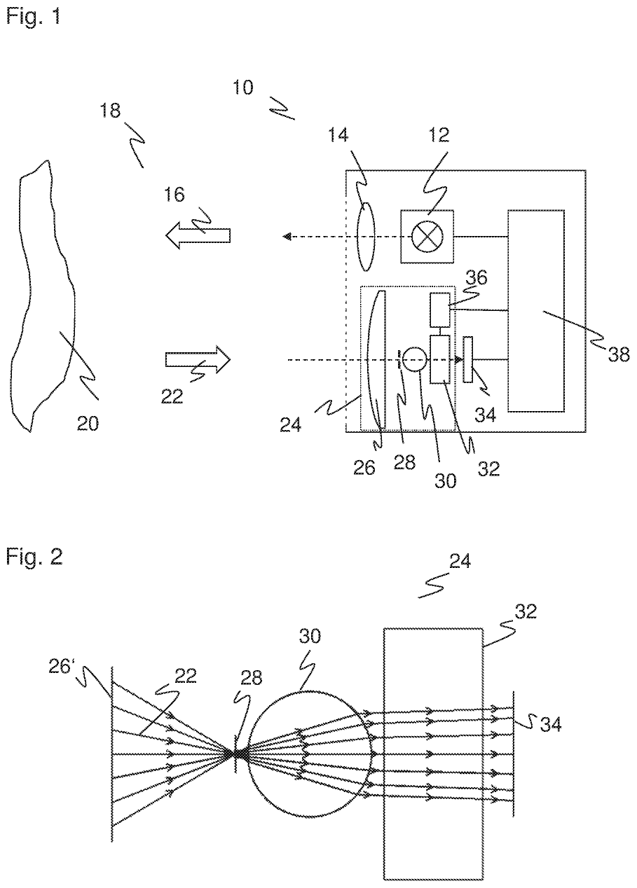

FIG. 1 a schematic representation of an optoelectronic sensor;

FIG. 2 a representation of the optical path in the reception with an optical filter of an optoelectronic sensor;

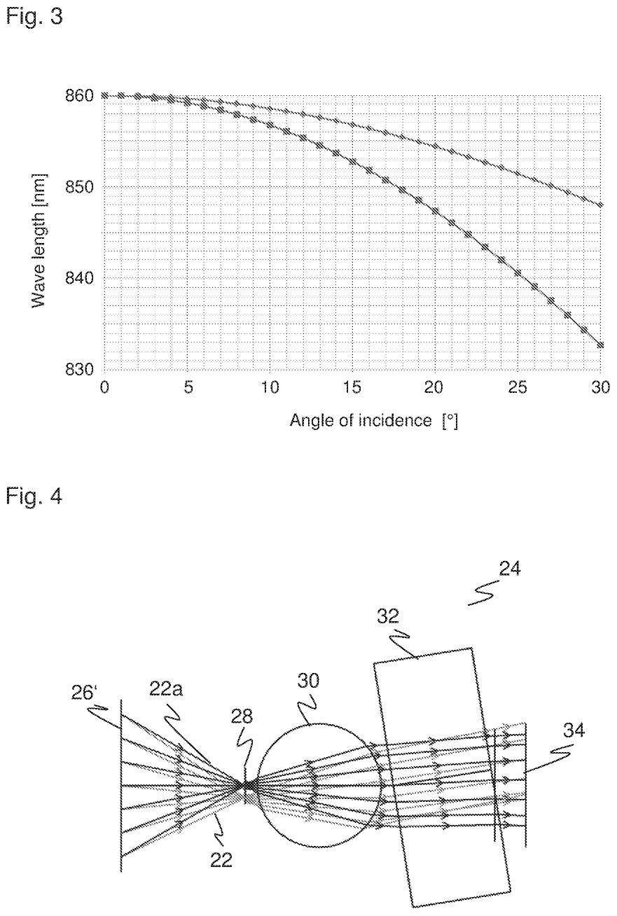

FIG. 3 exemplary extents of the center wavelength of an optical filter in dependence on the angle of incidence for two different refractive indices;

FIG. 4 a representation similar to FIG. 2, but now with a tilted optical filter for adapting the angle of incidence or the pass band; and

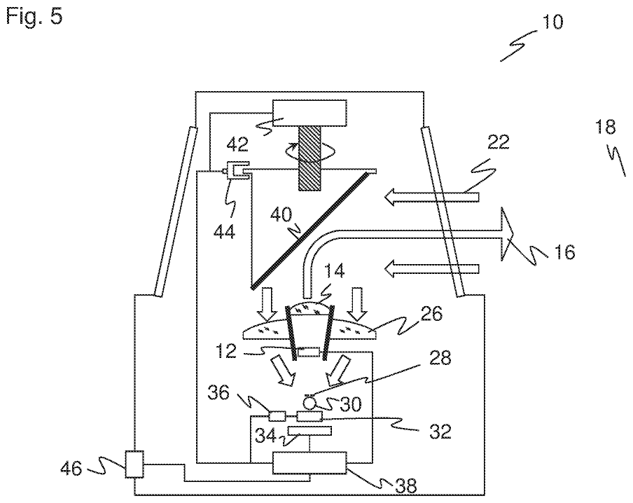

FIG. 5 a schematic representation of a laser scanner.

FIG. 1 shows a schematic sectional representation of an optoelectronic sensor 10. A light transmitter 12, for example a laser or an LED, transmits transmitted light 16 into a monitored zone 18 via a transmission optics 14. The light transmitter 12 preferably has a laser light source, in particular a semiconductor laser in the form of a VCSEL laser or an edge emitter, but also a different laser such as a fiber laser. A very tightly bounded wavelength range of the transmitted light 16 is thus possible. The light wavelengths used are typically between 200 nm and 2000 nm, In particular at 660 nm, 850 nm, 900 nm, and 1550 nm.

If the transmitted light 16 in the monitored zone 18 is incident on an object 20, a portion of the light returns to the sensor 10 as remitted transmitted light 22 and is there conducted to a light receiver 34 from a reception optics 24 having a first reception lens 26, a diaphragm 28, a second lens, preferably a spherical lens 30, and an optical filter 32. The optical filter 32 can be moved into different tilt positions with the aid of an adjustment device 36. The assembly and function of the reception optics 24 will be explained more exactly below with reference to FIGS. 2 to 4. The light receiver 34 is, for example, a PIN diode, an APD (avalanche photo diode), or a single photon APD (SPAD, a Geiger mode avalanche photo diode), or a multiple arrangement thereof.

A control and evaluation unit 38 controls the light transmitter 12 and evaluates the received signal of the light receiver 34 to acquire optically detectable information of the object 20, for example a binary presence detection, an object position, or a color. The control and evaluation unit 38 preferably determines a distance of the object 20 by means of triangulation or of a time of flight method. A time of flight process used here can be a single pulse process or a multiple pulse process, but can also be a phase process and is known per se.

The basic design of the sensor 10 in accordance with FIG. 1 is only to be understood as an example. Other arrangements are conceivable, for example a coaxial design instead of a biaxial design, and also different sensor types than a one-dimensional light scanner, in particular a laser scanner.

FIG. 2 again shows the reception path in front of the light receiver 34 and the optical path of the remitted transmitted light 22 in an enlarged representation. To provide an idea of the size, the spherical second lens 30 can, for example, have a diameter of approximately 1 mm. A plane 26′ behind the first reception lens 26 is shown instead of the first reception lens 26 since the dimensions of the first reception lens 26 or of the main lens amount to a multiple of the second lens 30, indeed in the centimeter range, and would burst the imaging scale.

The beams of the remitted transmitted light 22 are initially, at the left in FIG. 2, greatly converging due to the focusing of the first reception lens 26 and have different angles of incidence in the range of, for example, ±30°. The remitted transmitted light 22 is focused by the first reception lens 26 on the diaphragm 28 having a diaphragm aperture of 300 μm by way of example here. Lateral extraneous light that cannot originate from the light transmitter 12 for purely geometrical reasons is suppressed by the diaphragm effect.

The spherical second lens 30 then again aligns the beams largely in parallel with one another so that they are incident on the optical filter 32 at the same angle of incidence or at least in a small angle of incidence range of, for example, ±3°. The second lens 30 is configured as a glass ball, for example. The second lens 30 is very simple to handle due to its complete rotational symmetry and does not require any special orientation on insertion into its holder during production.

Due to its positioning in the already focused optical path of the remitted transmitted light 22, the optical filter 32 can be designed with a small surface in the order of magnitude of the light receiver 34. An area of, for example, 3×3 mm² of the optical filter 32 and of 1×1 mm² of the light receiver 34 is provided by way of example in FIG. 2. Since the light beams incident on the optical filter 32 have largely the same angle of incidence, the optical filter 32 can moreover be flat.

Conventionally, the pass band of a spectral filter typically has a full width at half maximum of 80 nm. The reason for the relatively large pass band is that reserves are kept back for drifts and for shifts of the wavelength range of the remitted transmitted light 22. Drifts characterize changes of the wavelength range over time due to effects such as component aging and above all a temperature dependence. This can still be manageable by correspondingly stable laser types as the light transmitter 12. A VCSEL, for example, only shows a fraction of the temperature dependence of a conventional edge emitter; as a numerical example only approximately a fifth at 0.06 nm/K. With a working range of the sensor 10 of 70 K, a drift of approximately 4 nm then results. It is also conceivable to use a temperature-stabilized light transmitter 12. The conventional reserves in the pass band of the optical filter 32 are therefore not required for temperature drift alone.

There are, however, additionally also shifts in the wavelength range. A tolerance of the central wavelength of the light transmitter 12 of 10-20 nm contributes to this and is caused by different batches and thus wafers and above all by the change to a light source of a different manufacturer and thus by a different manufacturing process.

In addition, the pass band of the optical filter 32 depends on the angle of incidence of the remitted transmitted light 22. If therefore the reception optics 24 is not adjusted as exactly as in FIG. 2 so that a perpendicular incidence is ensured, there are additional shift effects.

The spectral shift in dependence on the angle of incidence is illustrated in FIG. 3. The center frequency of an optical bandpass filter is therein drawn against the angle of incidence for two effective refractive indices n=2 (lower line) and n=3 (upper line).

In accordance with the invention, this is now used to adapt the pass band of the optical filter 32 to the wavelength range of the remitted transmitted light 22. The optical filter 32 is for this purpose tilted with the aid of the adjustment device 36. In this process, the adjustment device 36 can consist of the most simple mechanical means that only allow an adaptation within the framework of the production with corresponding tools and care. Conversely, an electronic actuator is also conceivable. It is not the means that is important here, but rather the result of the suitably tilted optical filter 32, optionally also simply by adhesive bonding or by any other fastening in the desired orientation. It is conceivable to already tilt the optical filter 32 in a base position. As FIG. 3 shows, a greater effect is produced the more the degree further to the right in the representation. If therefore a base position at an angle of incidence of 17° is selected, for example, a spectral range of ±5 nm is covered by ±5% adjustment angle.

FIG. 4 shows in a similar manner to FIG. 2 the reception path of the remitted transmitted light 22, but now with a tilted optical filter 32, in this example by approximately 9°. This produces a perpendicular angle of incidence for the beams of the remitted transmitted light 22a shown lighter. For comparison, beams shown as dark extending centrally through the diaphragm 28 are also drawn. These are only two examples of the effects of maladjustment and tilt. The actually desired tilt angle is that angle at which the pass band of the optical filter is adapted as well as possible to the wavelength range of the incident remitted transmitted light 22. This in no way has to correspond to a perpendicular incidence; the tilt angle is rather actually the setting parameter, as can be recognized from FIG. 3. The optimization is practically possible in that, with an activated light transmitter 12 and darkness or extraneous light conditions that are as constant as possible, the optical filter 32 is tilted for so long until the reception level of the light receiver 34 is at a maximum. It has already been pointed out in connection with FIG. 3 that such a shift and adaptation of the pass band of the optical filter 32 of ±5 nm or also ±10 nm is possible.

It is therefore possible overall to use an optical filter 32 and in particular a bandpass filter having a full width at half maximum of only 20 run or even only of 10 nm and nevertheless to still also allow the total useful light to pass with remaining drifting. The extraneous light is thereby reduced by a factor of four or eight with respect to a conventional full width at half maximum of 80 run. Since all the useful light is still transmitted with a correctly set tilt angle of the optical filter 32, the signal-to-noise ratio is improved accordingly.

FIG. 5 shows a schematic sectional representation through an embodiment of the optoelectronic sensor 10 as a laser scanner. In this respect, features already known from FIG. 1 are provided with the same reference numerals and will not be described again. Unlike in FIG. 1, the optical path of the transmitted light 16 and of the remitted transmitted light 22 runs via a deflection unit 40.

The deflection unit 40 is set into a continuous rotational movement having a scan frequency by a motor 42. The transmitted light 16 thereby scans one plane during each scan period, that is on a complete revolution. An angle measurement device 44 is arranged at the outer periphery of the detection unit 40 to detect the respective angular position of the detection unit 40. The angle measurement device 44 is here formed, by way of example by an encoder wheel as an angular standard and a forked light barrier as a scanning device.

The control and evaluation unit 38 is also connected, as well as to the light transmitter 12 and to the light receiver 34, to the motor 42, and to the angle measurement unit 44. It determines the distance from the respectively scanned object using a time of flight method known per se. Measurement points or contours are therefore detected in polar coordinates together with the respective angle provided by the angle measurement unit 44. These measurement points are output as raw data at an output 46 or in the control and evaluation unit 36 as measured results internally determined therefrom.

In the laser scanner shown, the light transmitter 12 and its transmission optics 14 are located in a central opening of the reception optics 24. A coaxial arrangement is thereby produced. This can alternatively also be achieved with a separate mirror region for the transmitted light 16 or with a beam splitter. As already stated with respect to FIG. 1, the sensor 10 shown there can alternatively also have a coaxial design, just as a biaxial laser scanner is conversely possible. Further alternative designs of a laser scanner do not use a rotating mirror as the deflection unit 40, but rather cause the total measuring head with the light transmitter 12 and the light receiver 34 to rotate.

1. An optoelectronic sensor for detecting an object in a monitored zone, the optoelectronic sensor comprising:
a light transmitter for transmitting transmitted light of a wavelength range;
a light receiver for producing a received signal from the transmitted light remitted at the object;
a reception optics that is arranged upstream of the light receiver and that has an optical filter adapted to the wavelength range for suppressing extraneous light;
a control and evaluation unit that is configured to produce a piece of object information from the received signal; and
an adjustment device for changing the angle of incidence of the remitted transmitted light on the optical filter.

2. The optoelectronic sensor in accordance with claim 1,
wherein the adjustment device is configured to tilt the optical filter.

3. The optoelectronic sensor in accordance with claim 1,
wherein the optical filter is a bandpass filter.

4. The optoelectronic sensor in accordance with claim 1,
wherein the wavelength range is shifted in a tolerance wavelength range due to drifting in the operation of the optoelectronic sensor and/or due to properties of the light transmitter; and wherein the optical filter has a pass band that is narrower than the tolerance wavelength range.

5. The optoelectronic sensor in accordance with claim 1,
wherein the optical filter has a pass band having a full width at half maximum of one of at most 20 nm and at most 10 run.

6. The optoelectronic sensor in accordance with claim 1,
wherein the optical filter is planar.

7. The optoelectronic sensor in accordance with claim 1,
wherein the optical filter has an area of one of at most 20 mm² and at most 10 mm².

8. The optoelectronic sensor in accordance with claim 1,
wherein the wavelength range of the light transmitter shifts with the temperature by one of at most 0.1 nm/K and at most 0.05 nm/K.

9. The optoelectronic sensor in accordance with claim 1,
wherein the reception optics has a first focusing optical element.

10. The optoelectronic sensor in accordance with claim 9,
wherein the reception optics has a first focusing optical element with a diaphragm arranged downstream.

11. The optoelectronic sensor in accordance with claim 1,
wherein the reception optics has a second focusing optical element.

12. The optoelectronic sensor in accordance with claim 11,
wherein the reception optics has a spherical converging lens as the second focusing optical element.

13. The optoelectronic sensor in accordance with claim 11,
wherein the adjustment device is configured to tilt the optical filter and the second focusing optical element.

14. The optoelectronic sensor in accordance with claim 13,
wherein the adjustment device is configured to tilt the optical filter and the second focusing optical element, with a center of rotation in the second focusing optical element.

15. The optoelectronic sensor in accordance with claim 1,
wherein the reception optics has, in this order, a first focusing optical element, a diaphragm, a second focusing optical element, and the optical filter.

16. The optoelectronic sensor in accordance with claim 1,
wherein the control and evaluation unit is configured to determine a distance of the object from a time of flight between the transmission of the transmitted light and the reception of the remitted transmitted light.

17. The optoelectronic sensor in accordance with claim 1,
that is configured as a laser scanner and has a movable deflection unit for the periodic scanning of the transmitted light in the monitored zone.

18. A method of detecting an object in a monitored zone, in which method:
transmitted light is transmitted in a wavelength range,
is received again after remission at the object as remitted transmitted light by a reception optics, and
is converted into a received signal to produce a piece of object information from the received signal, wherein the reception optics suppresses extraneous light by an optical filter adapted to the wavelength range, and the angle of incidence of the remitted transmitted light on the optical filter is set to adapt a pass band of the optical filter to the wavelength range.
